(19) United States
(12) Patent Application Publication
(10) Pub. No.: US 2020/0395959 A1
(43) Pub. Date: Dec. 17, 2020

(54) System and Method for Next Generation Television Broadcast

(71) Applicant: Edge Networks, Inc., Sun Valley, ID (US)

(72) Inventors: Andreas Gluck, San Diego, CA (US); Todd Achilles, Sun Valley, ID (US)

(73) Assignee: Edge Networks, Inc., Sun Valley, ID (US)

(21) Appl. No.: 16/833,709

(22) Filed: Mar. 30, 2020

Related U.S. Application Data
(60) Provisional application No. 62/860,799, filed on Jun. 13, 2019.

(51) Int. Cl. H04B 1/00; H04B 1/10; H04B 1/18; H04W 48/18

(52) U.S. Cl. CPC H04B 1/006; H04B 1/1036; H04B 1/0064; H04W 48/18; H04B 1/18

(57) ABSTRACT

A system for receiving communication signals includes a plurality of antennas, a receiver having a plurality of tuners each configured to be connected to one of the antennas, and a plurality of switching devices each associated with one of the plurality of tuners wherein the switching devices facilitate selective connection of the associated tuners with at least one of the plurality of antennas.

### RELATED APPLICATIONS/CLAIM FOR PRIORITY

This application claims the benefit of the filing date of U.S. Provisional Application No. 62/860,799 filed on Jun. 13, 2019. This application is also related to U.S. Provisional Application No. 62/831,136 filed on Apr. 8, 2019 and to U.S. patent application Ser. No. 16/578,159 filed on Sep. 20, 2019, Ser. No. 16/591,767 filed on Oct. 3, 2019 and Ser. No. 16/664,808 filed on Oct. 26, 2019. The subject matter of each of these applications is incorporated herein in its entirety by reference.

### BACKGROUND

The present disclosure is directed to television (TV) broadcasting and more particularly to intelligent broadcast reception systems and methods.

Traditional (and current) end-user television antennas are designed for over-the-air broadcast systems. Television broadcast transmitters, mounted on transmission towers for example, are co-located at a common location within a media market. The common location may be an elevated site for example. Viewers/users install a directional antenna on or in their home. A coaxial cable may provide a connection between the antenna and a TV. Signals received by the antenna and carried over the cable may be processed by a tuner within the TV to facilitate viewing of content on one of a plurality of channels selected by the viewer.

In a traditional broadcast market (such as a designated market area or DMA), it is unusual for TV broadcast transmission towers to be deployed at different physical locations. Such an arrangement may require a viewer or user to re-point the antenna for viewing the different channels. Existing broadcast technologies are not designed to support secondary transmission locations (single frequency network—SFN) nor do they assume that signals are widely distributed within a DMA.

A recently adopted television standard, ATSC 3.0 (Advanced Television Systems Committee) provides for the broadcast (over the air, OTA) of television signals in a format that is similar to the format of data that is communicated over a broadband/internet connection.

Next generation TV (NGTV), OFDM (orthogonal frequency division multiplexing) based air interface protocols (such as DVB-T2 and ATSC 3.0) offer higher capacity and improved services. In existing systems, if the signal is good, there's no change in the number of services, channels or quality. Since OFDM systems are more adaptive, better radio links provide more services and higher quality.

Traditional passive, residential TV antennas rely on tuners and demodulators located in the television.

ATSC 3.0 supports secondary broadcast sites in a market (SFN). Such secondary sites are similar to a mobile network in that they could be deployed at different locations within a media market. As highlighted above, in a traditional set up, all or multiple broadcasters (in a particular DMA) generally operate from a common location so that residential directional antennas can be pointed in one direction to capture substantially all the available TV channels.

In a NGTV system, the strongest signals for each channel could be scattered throughout the market. A future viewer could face a situation where available NGTV channels may be located in 360 degrees around their home.

Advanced antenna systems and methods are needed to take advantage of the new TV interface protocols. Advanced antenna arrangements can leverage high modulation and encoding systems coupled with advanced concepts such as receive diversity and multiple-input-multiple-output (MIMO) systems.

### SUMMARY

According to an example embodiment, a system for receiving communication signals is disclosed. The system comprises: a plurality of antennas; a receiver including a plurality of tuners each configured to be connected to one of the antennas; and a plurality of switching devices each associated with one of the plurality of tuners, the switching devices facilitating selective connection of the associated tuners with at least one of the plurality of antennas.

According to another example embodiment, a method for processing communication signals is disclosed. The method comprises: selecting a channel from a plurality of channels on which to receive content; selecting an antenna from a plurality of antennas, the selected antenna being optimized for receiving signals for the selected channel; tuning to the selected channel from the selected antenna; processing data from the tuned channel; and displaying content from the processed data.

According to a further example embodiment, a non-transitory computer-readable medium is disclosed. The medium has instructions stored thereon for execution by a processor of a controller. The instructions cause the processor to: receive a channel selection from a user; select an antenna from a plurality of antennas, the selected antenna being optimized for receiving signals for the selected channel; tune to the selected channel from the selected antenna; process data from the tuned channel; and display content from the processed data.

### BRIEF DESCRIPTION OF THE DRAWINGS

The several features, objects, and advantages of example embodiments will be understood by reading this description in conjunction with the drawings. The same reference numbers in different drawings identify the same or similar elements. In the drawings:

FIG. 1 illustrates a block diagram of an example communication system of the present disclosure;

FIG. 2 illustrates a block diagram of an example antenna arrangement of the present disclosure;

FIG. 3 illustrates a block diagram of an example antenna-tuner arrangement of the present disclosure;

FIG. 4 illustrates an example heterodyne receiver of the present disclosure;

FIG. 5 illustrates an example full band capture receiver of the present disclosure;

FIG. 6 illustrates a block diagram of an example communication system of the present disclosure;

FIG. 7 illustrates a flow chart of an example method of the present disclosure for processing communication signals; and

FIG. 8 illustrates an example controller for implementing a communication signal processing system of the present disclosure.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the example embodiments.

Reference throughout this specification to an “example embodiment” or “example embodiments” means that a particular feature, structure, or characteristic as described is included in at least one embodiment. Thus, the appearances of these terms and similar phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

In an example scenario, a family of four persons may be watching television. Three of the viewers may be watching channel 18 while the fourth may be watching channel 30. Simultaneously, the DVR of a set-top box may be recording two programs—one from channel 8 and one from channel 26.

Channels 8 and 30 may be broadcasting from a co-located broadcast tower along an azimuth of 30° from the house. The strongest broadcast site for channel 18 may be a small SFN located at an azimuth of 190° from the house. Channel 26 may have a SFN located at an azimuth of 300° from the house.

An example system in accordance with the present disclosure may receive signals from three broadcast sites in order to facilitate the viewer preferences/selections identified above. In the example above, four tuners and demodulators may be implemented. Each of the tuners may tune into one of the four channels. A corresponding demodulator may demodulate the signal received by the tuner into an IP-based stream that is delivered over Ethernet to the home STB for viewing or recording.

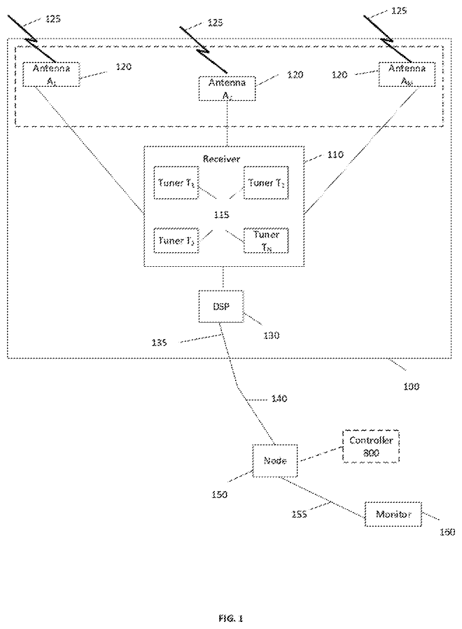

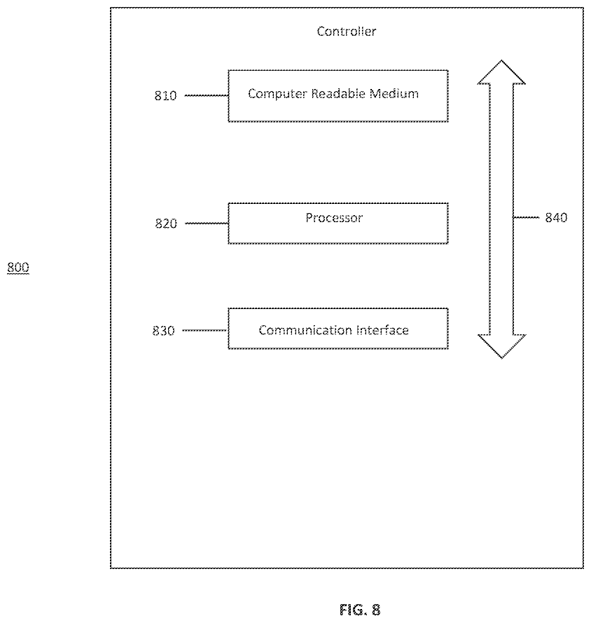

According to an example embodiment, a receiver 110 may be co-located (i.e. in close proximity) with one or more antennas 120 as illustrated in FIG. 1. The receiver 110 may include multiple (N) tuners 115 (T₁, T₂, T₃, . . . T_{N} for example). There may also be multiple (M) antennas (designated A₁, A₂, . . . , A_{M} for example) receiving signals 125. The location of the antennas 120 are purely for illustrative purposes and do not depict the actual directional or proximal location with respect to the receiver 110. Various components (i.e. tuners, antennas, DSP) are illustrated as being included within unit 100 of FIG. 1 to indicate their co-location or to indicate that they are integrated within a physical enclosure for example. A controller 800 may also be included in box 100 and is described in further detail below with reference to FIG. 8.

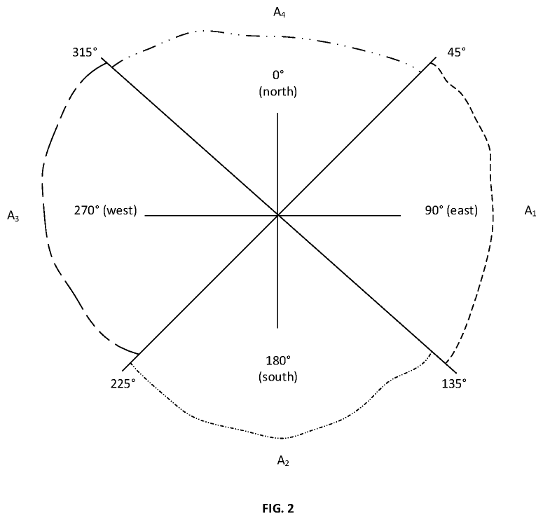

The antennas 120 may be directional antennas each covering a particular angular range. The sum of the coverage range of the M antennas may add up to 360° (degrees). In a simple example, four directional antennas may be implemented each covering 90°. As illustrated in FIG. 2, antenna A₁ (east) may receive signals between 45° and 135°; antenna A₂ (south) may receive signals between 135° and 225°; antenna A₃ (west) may receive signals between 225° and 315° and antenna A₄ (north) may receive signals between 315° and 45°.

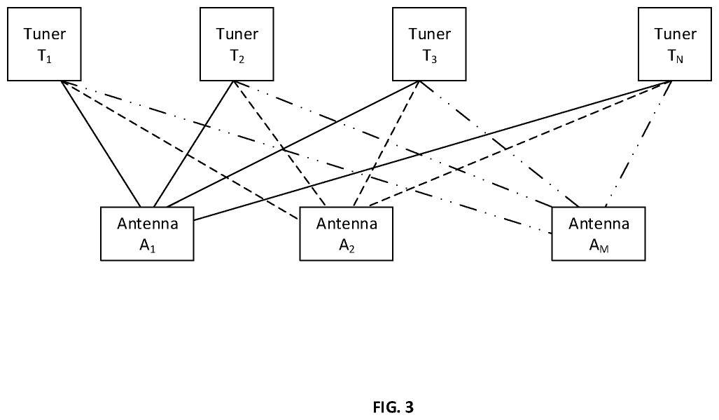

Each tuner 115 can be connected to any one of the antennas 120 at a time. Multiple tuners 115 can be connected to one antenna 120 at a time. A tuner 115 cannot be connected to multiple antennas 120 at a time. An example of multiple tuners T₁, T₂, T₃, . . . , T_{N} having connection(s) to multiple antennas A₁, A₂, . . . , A_{N} is illustrated in FIG. 3.

The co-location (of an antenna and a receiver/tuner) minimizes the path losses typically associated with a (e.g. coaxial) cable that connects the TV/tuner to an antenna. The co-location improves the system noise performance. The co-location can also eliminate ingress noise that may result from the electrical system (of the home or dwelling) that is coupled to the coaxial cable if in close proximity. Referring back to FIG. 1, unit 100 (i.e. antenna 120 and receiver 110 with tuner(s) 115) can be placed either external or internal to the home/dwelling depending on signal conditions.

The combined unit 100 may also include a digital signal processor (DSP) 130 for processing the received signals. The processed signals 135 may be communicated using standard IP (or other suitable) protocols. The signals may be communicated via a wired or wireless medium 140. The wired connection may be Ethernet or fiber optic connection using a CAT5, a CAT6 or a similar cable. The signals may also (even simultaneously) be communicated via a wireless medium using a Wi-Fi or other high speed wireless standards. An Ethernet wired connection has the additional advantage of supplying power to the antenna and tuner unit which further simplifies installation.

The processed signals can terminate at an existing network node 150 or may form a new independent network with a receiving end node connecting via a wired or wireless medium 155 to a display mechanism such as a monitor 160 for example. The network node can receive signals from the various antennas and processed by the various tuners. The network node can be connected to a set top box (STB). The set top box can provide data signals corresponding to audio and video (still or streaming) to the monitor. The set top box can also receive inputs from users corresponding to the channels the user wishes to view (such as via a remote control) for example.

Each tuner may 115 operate simultaneously or independently of the others (i.e. other tuners) and tune to any frequency that can be received by each of the antennas 120. An antenna can receive signals corresponding to multiple frequencies. Signals corresponding to a frequency can be received (simultaneously) by multiple, or even all, antennas in a system.

In one example, receiver 110 may be a super heterodyne receiver that can tune to a single frequency in a single channel bandwidth (such as a TV channel for example).

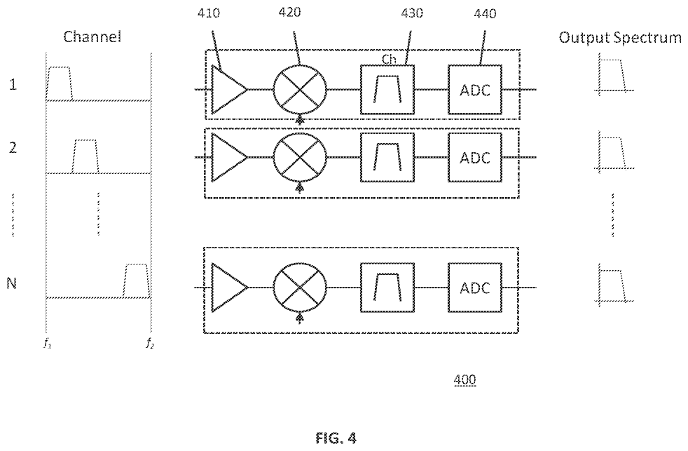

An example of a super heterodyne receiver is illustrated in FIG. 4. Super heterodyne receiver 400 as illustrated includes a plurality of tuners each shown enclosed within a dashed box. Each tuner may be connected to an antenna and include an amplifier 410 for amplifying signal(s) received via the antenna. The amplified signal may be downconverted by a downconverter/mixer 420. The downconverted signal may be filtered by a channel filter 430. The filtered signal may be converted from an analog to a digital signal by the analog-to-digital converter (ADC) 440. The output of the tuner may be communicated to a network node.

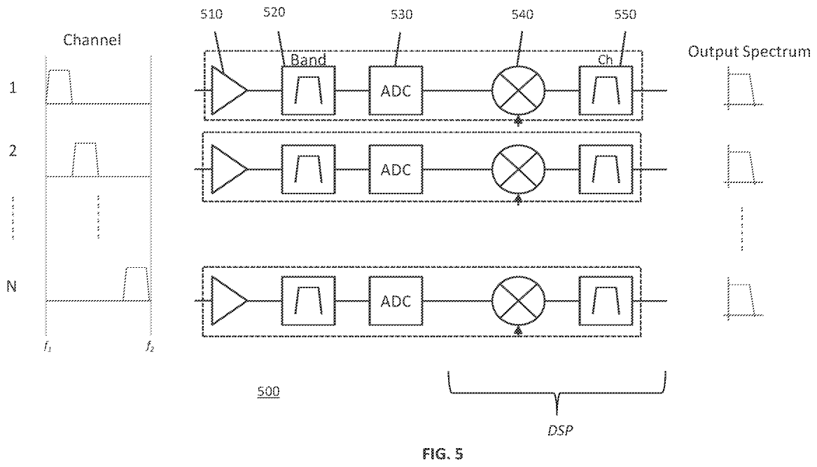

In another example, receiver 115 may be a full band capture receiver that can receive the entire frequency band (UHF band for example). The received radio frequency (RF) signals can be digitized directly without down converting to an intermediate frequency (IF). With full band receivers, multiple digital tuners (N) and filtering schemes may be implemented in order to extract the independent channels. An example of a full band capture receiver is illustrated in FIG. 5.

Full band capture receiver 500 as illustrated includes a plurality of tuners each shown enclosed within a dashed box. Each tuner may be connected to an antenna and include an amplifier 510 for amplifying signal(s) received via the antenna. The amplified signal may be filtered by a band filter 520. The filtered signal may be converted from an analog to a digital signal by the analog-to-digital converter (ADC) 530. The digital signal may be downconverted by a plurality of downconverters 540 (one per channel). The channels may be filtered by channel filter(s) 550. The output of the tuner may be communicated to a network node.

Embodiments as described herein provide for processing multiple frequencies from each of a plurality of antennas.

As described briefly above with respect to FIG. 2, a plurality (M) of antennas may be divided into a number of sectors with each sector covering (360/M°) in the azimuth plane. Each of the N tuners can choose one of the M antennas based on signal strength for a desired channel for example. Utilizing such devices as switches, splitters and low noise amplifiers (LNAs), embodiments as described herein can be implemented in existing tuners. One limiting factor may be the physical dimensions necessary for implementing multiple antennas.

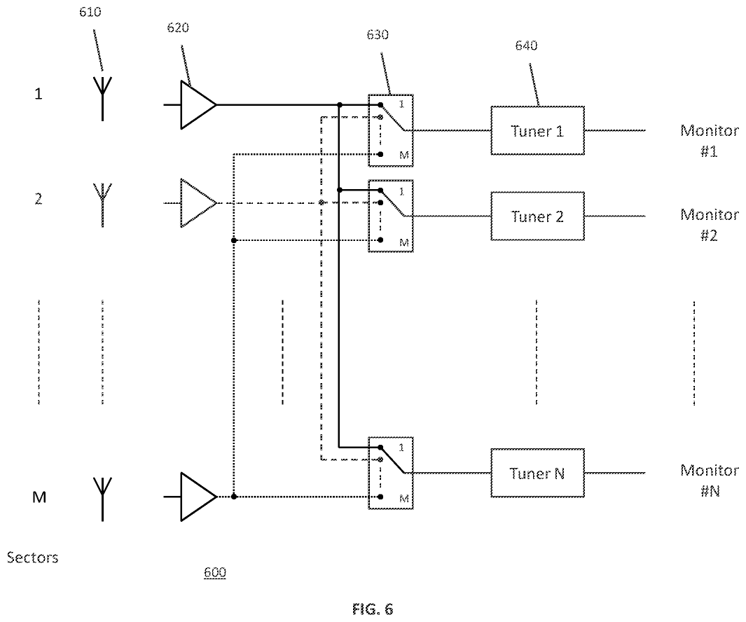

A system 600 incorporating M antennas 610 (or antenna elements or sectors) is illustrated in FIG. 6. System 600 may also include a plurality (N) of tuners 640. Tuners 640 may be such as those illustrated (included within the dashed boxes) and described above with reference to FIGS. 4 and 5.

A first one of the tuners (i.e. Tuner 1) may be connected to one of antennas 1, 2, . . . , M at a time. Each of the remaining tuners 2, . . . , N may also be similarly connected to one of antennas 1, 2, . . . , M at a time. The received signal(s) may be amplified by amplifier(s) 620. Each tuner 640 may have a switching mechanism 630 associated therewith for switching between the antennas. Amplifier 620 may be an additional amplifier outside the tuner. Amplifier 620 can also substitute for the amplifier included in the tuner.

If the number of antennas is four (4) for example, the switching mechanism 630 may provide a tuner (such as Tuner 1) the ability to switch between the four antennas.

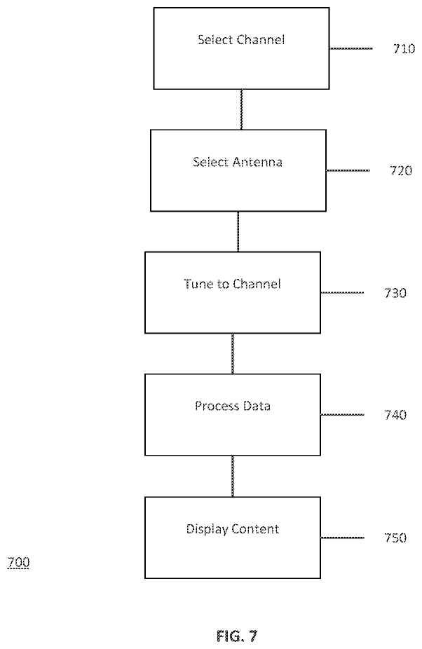

An example of a method for receiving media content (such as television programming) from a source is described with reference to FIG. 7. In method 700, a channel may be selected from a plurality of channels at 710. An antenna from a plurality of antennas may be selected at 720. The selected antenna may be the antenna that is optimized for receiving signals for the selected channel. A tuner may tune to the selected channel from the selected antenna at 730. Data, such as television programming received from the selected channel, may be processed at 740. The content of the television programming may be displayed at 750 on the monitor associated with a user.

For each of the available channel frequencies, a particular antenna from the plurality of antennas may be identified as being the antenna having an optimum or desired channel quality. The optimum antenna may be selected based on signal strength or other performance parameter(s). As highlighted above, a signal from a channel can be received by more than one of the plurality of M antennas.

In some embodiments, the association between channels and antennas may be stored in a lookup table. A system in accordance with the disclosure may also execute a process on a periodic basis for identifying or updating an optimum antenna for each of the channels. This process may be executed on a scheduled basis such as on the weekends at 2 AM for example. Channel signal quality may also be evaluated on an ongoing basis while the tuner is processing the signal.

A controller may be included within the system described herein. Controller 800, as illustrated in FIG. 8, can coordinate the various actions described. Controller 800 may include a machine-readable medium 810, a processor 820, a communications interface 830 and a system bus 840. The various components of controller 800 may interconnect and communicate via bus 840. Controller 800 is not limited to include the components illustrated—it can include more or less components than those depicted. Controller 800 can be located at the network node for example (FIG. 1). An uplink communication between controller 800 and tuners 115 may occur via path other than that illustrated in FIG. 1 such as bypassing DSP 130.

The machine-readable medium 810 may be any electronic, magnetic, optical, or other physical storage device that stores executable instructions. The machine-readable medium 810 can be encoded to store executable instructions that cause the processor 820 to perform operations, methods and processes in accordance with various examples described herein. In various examples, the machine-readable medium 810 may be non-transitory.

The processor 820 may be one or more central processing units (CPUs), microprocessors, or other hardware devices suitable for retrieval and execution of one or more instructions stored in the machine-readable medium 810. The processor 820 may fetch, decode, and execute the instructions to enable the controller 800 to perform operations in accordance with various examples described herein. For some examples, the processor 820 includes one or more electronic circuits comprising a number of electronic components for performing the functionality of one or more of the instructions included in the methods described above (for example, in FIG. 7).

The communications interface 830 may facilitate data communications between the controller 800 and the user. The communication may include receiving a user selection (such as channel selection) for example. Communication interface 830 can also facilitate communication between controller 800 and switch 630 (of FIG. 6). Controller can also facilitate signal strength monitoring as described above.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A system for receiving communication signals comprising:
a plurality of antennas;
a receiver including a plurality of tuners, each configured to be connected to one of the antennas; and
a plurality of switching devices each associated with one of the plurality of tuners, the switching device facilitating selective connection of the associated tuner with at least one of the plurality of antennas.

2. The system of claim 1, wherein a number of the plurality of tuners is independent of a number of the plurality of antennas.

3. The system of claim 1, wherein at least one of the plurality of antennas is simultaneously connected to at least two of the plurality of tuners.

4. The system of claim 1, wherein each of the plurality of antennas is a directional antenna.

5. The system of claim 4, wherein a coverage area for each antenna is a sector covering a portion of an azimuth plane.

6. The system of claim 5, wherein a combined coverage area of the plurality of sectors corresponding to the plurality of antennas is 360°.

7. The system of claim 1, wherein the receiver is a heterodyne receiver.

8. The system of claim 1, wherein the receiver is a full band capture receiver.

9. The system of claim 1, wherein each of the plurality of tuners is connected to a display mechanism.

10. The system of claim 9, wherein the display mechanism is a monitor.

11. A method for processing communication signals, comprising:
selecting a channel from a plurality of channels on which to receive content;
selecting an antenna from a plurality of antennas, the selected antenna being optimized for receiving signals for the selected channel;
tuning to the selected channel from the selected antenna;
processing data from the tuned channel; and
displaying content from the processed data.

12. The method of claim 11, wherein an identification of the optimized antenna is based on a predefined association between each of the plurality of channels and one of the plurality of antennas.

13. The method of claim 12, further comprising:
storing an association between the plurality of channels and the plurality of antennas in a lookup table.

14. The method of claim 13, further comprising:
tuning to a channel via each of the plurality of antennas;
evaluating quality of signal received for the channel from each one of the antennas;
identifying an antenna associated with a highest evaluated quality; and
storing an identify of the channel and of the associated antenna having the highest signal quality in a lookup table.

15. The method of claim 14, further comprising:
periodically performing the signal strength evaluation to update the lookup table.

16. A non-transitory computer-readable medium having instructions stored thereon, the instructions being executable by a processor of a controller, the instructions causing the processor to:
receive a channel selection from a user;
select an antenna from a plurality of antennas, the selected antenna being optimized for receiving signals for the selected channel;
tune to the selected channel from the selected antenna;
process data from the tuned channel; and
display content from the processed data.
